(19) United States
(12) Patent Application Publication
(10) Pub. No.: US 2010/0015000 A1
(43) Pub. Date: Jan. 21, 2010

(54) APPARATUS FOR SIMULTANEOUS SUPPORT OF PRESSURIZED AND UNPRESSURIZED MECHANICAL SHAFT SEALING BARRIER FLUID SYSTEMS

(75) Inventors: Dale B. Andrews, Derry, NH (US); Jason D. Allaire, Wells, ME (US)

Correspondence Address: Vern Maine & Associates, 100 MAIN STREET, P O BOX 3445, NASHUA, NH, 03061-3445, US

(73) Assignee: Lawrence Pumps, Inc.

(21) Appl. No.: 12/504,744

(22) Filed: Jul. 17, 2009

Related U.S. Application Data
(60) Provisional application No. 61/081,522, filed on Jul. 17, 2008.

(51) Int. Cl. F16J 15/40; F04C 27/00; F04D 29/08; F16J 15/48; F16J 15/54

(52) U.S. Cl. 418/88; 418/84; 277/304; 415/112

(57) ABSTRACT

An improved, piston-based, pressure-transforming barrier fluid support apparatus is disclosed that can support both the pressurized and unpressurized barrier fluid requirements of a shaft-driven machine from a single unit. The disclosed apparatus includes both a pressurized section that stores, cools, cleans, and pressure regulates pressurized barrier fluid, and an unpressurized section that stores, cools, and cleans unpressurized barrier fluid. The disclosed apparatus causes debris in the pressurized barrier fluid to gravitationally migrate away from the piston, so as to prevent piston fouling. If the piston rod becomes detached, it is expelled downward for enhanced safety. Removable covers and/or a removable cylinder can provide enhanced access for cleaning and maintenance. Embodiments include a common cover that is shared by the pressurized and unpressurized sections and serves as a common manifold for cost-efficient fluid connections thereto.

### RELATED APPLICATIONS

This application claims the benefit of U.S. Provisional Applications No. 61/081,522, filed Jul. 17, 2008, herein incorporated by reference in its entirety for all purposes.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates to systems for supporting the barrier fluid requirements of shaft seals in a shaft-driven machine, and more particularly to systems for supporting pressurized and unpressurized barrier fluid requirements of shaft seals in shaft-driven machinery.

### BACKGROUND OF THE INVENTION

Shaft-driven machinery such as pumps used in the transport of process fluids often use mechanical shaft seals to prevent leakage of fluid from the process side of the equipment to the atmosphere. In many instances, the process fluid being sealed is hazardous to health, hazardous to the environment, and/or volatile to such an extent that it is necessary to prevent any leakage whatsoever of the process fluid into the atmosphere, where unwanted reactions might occur. A typical example is a loop reactor pump that is used to supply cyclohexane or ethylene at 400 degrees Fahrenheit and 600 psi to a polyethylene or polypropylene synthesizing process.

To protect against any possible process fluid leakage, a shaft sealing system is typically used that includes at least two shaft seals with a pressure sealing region therebetween in which a barrier fluid is maintained at a pressure higher than the process pressure, so that any leakage will be into the process region rather than out of the process region. An additional “safety” shaft seal is often included on the ambient side of the pressure sealing region, thereby forming a second, unpressurized sealing region in which barrier fluid is maintained at substantially ambient pressure. Typically, such shaft sealing systems require pressurized and/or unpressurized barrier fluid to be circulated between the sealing chambers and barrier fluid reservoirs that cool, store, clean, and, in the case of pressurized systems, regulate the pressures of the barrier fluids.

One common approach for maintaining barrier fluid at a pressure above a process fluid pressure uses a pressure-transforming piston enclosed within a hydraulically filled and pressurized cylinder to maintain a constant pressure differential between the process fluid and the pressurized barrier fluid system. Hydraulic fluid located on the “sensing side” of the piston communicates with the process pressure through interconnecting piping, while barrier fluid is circulated between the “barrier fluid” side of the piston and the pressurized sealing chamber(s) through a separate system of interconnecting piping.

A piston rod attached to the barrier fluid side of the piston extends vertically upward from the piston along the longitudinal axis of the cylinder and beyond the pressurized cylinder through a series of contacting pressure seals. The effective piston surface area on the barrier fluid side of the piston is thereby reduced by the cross-sectional area of the piston rod. Because the pressure cylinder is full of hydraulic barrier fluid, and due to the resulting difference in effective surface areas on the two sides of the piston, a greater pressure is required on the barrier fluid side of the piston so as to balance the force applied to the sensing side of the piston, thereby maintaining a constant pressure differential between the process pressure and the barrier fluid pressure that is equal to the ratio of the effective surface areas of the sensing side and the barrier fluid side of the piston. A series of piston rings mounted in grooves that encircle the piston contact the cylinder wall and isolate the sensing side of the piston from the barrier fluid side of the piston. As barrier fluid is added or consumed, the position of the piston shifts within the cylinder so as to compensate, and a constant pressure differential is maintained.

Generally, pressurized barrier fluid systems of the piston type include a separate pressurized vessel that performs the task of cooling, cleaning, and storing the pressurized barrier fluid. Installations that also require unpressurized barrier fluid typically include an additional unpressurized vessel that cools, stores, and cleans the unpressurized barrier fluid. Each vessel requires separate pressure testing, foundations, and interconnecting piping, thereby consuming space and increasing costs.

In an effort to reduce the number of barrier fluid vessels required in a barrier fluid support system, single pressurized vessels have been developed that can cool, clean, store, and regulate the pressure of barrier fluid. However, the number and complexity of the required fluid connections substantially raises the cost of such vessels, and additional vessels are still required when unpressurized barrier fluid is also needed.

All of these known, piston-based approaches suffer from a common deficiency, in that debris that naturally circulates within such barrier fluid systems as a result of wear to the mechanical seal faces tends to settle on the piston rings, and this can interfere with the sliding motion of the rings against the cylinder wall, and can possibly cause the piston to foul. Furthermore, many of the known pressurized and unpressurized barrier fluid support system vessels lack an access feature to expedite cleaning, and this increases the risk of damage to the piston and mechanical seals due to the circulation of particulate contaminates that are not easily removable from the vessels.

Thus, there is a need for a barrier fluid support unit for use in a pressurized barrier fluid support system that performs the tasks of cooling, cleaning, storing, and regulating the pressure of the barrier fluid, while also minimizing cost, optimizing compactness, and preventing exposure of the piston rings to any debris that may settle from the circulating barrier fluid. A further need exists for such a barrier fluid support unit to additionally perform the tasks cooling, cleaning, storing, and supplying unpressurized barrier fluid.

### SUMMARY OF THE INVENTION

An improved, piston-based, pressure-transforming barrier fluid support apparatus is claimed that stores, cools, cleans, and regulates the pressure of barrier fluid in a pressurized mechanical seal system, while at the same time storing, cooling, and cleaning barrier fluid in an unpressurized mechanical seal system, such that both the pressurized and unpressurized sections are housed in a single assembly. The claimed barrier fluid support system is configured so as to cause any debris to gravitationally migrate away from the piston, and some embodiments include a common cover that is shared by the pressurized and unpressurized sections and serves as a common manifold that provides for cost-efficient fluid connection thereto. Embodiments of the claimed apparatus also include removable covers and/or removable cylinders so as to provide access for cleaning of the piston and surrounding interior environment.

Embodiments of the claimed apparatus include a piston that is engaged with a cylinder and a piston rod that extends downward from the piston, thereby locating the pressurized barrier fluid region below the piston, and causing solid contaminants contained in the pressurized barrier fluid to gravitationally settle below the piston. This arrangement, combined in some embodiments with commercially available scraper/wiper rings and seals, operates to prevent fouling of the piston and interference of motion between the piston rings and the cylinder walls. This arrangement also enhances the safety of nearby equipment and personnel, since it ensures that if the piston rod should be come detached from the piston, it will be ejected downward toward the foundation, and not upward into the surrounding environment.

Some embodiments of the present invention that include an unpressurized barrier fluid unit are assembled such that the pressurized unit and the unpressurized unit share a common cover that serves as a shared manifold for many of the assembly piping connections, thereby reducing the number of piping penetrations in the pressurized and unpressurized units, simplifying construction, and reducing cost. Various embodiments include removable covers that enable both the pressurized unit and the unpressurized unit to be readily accessed for cleaning. In certain of these embodiments, the unpressurized unit is attached below the pressurized unit, and the portion of the piston rod that extends below the pressurized unit is contained within the unpressurized unit. In other of these embodiments, the unpressurized unit is mounted above the pressurized unit, so as to facilitate location of the unpressurized unit above the shaft seals, so that any gas that collects in the unpressurized barrier fluid system will tend to accumulate at the top of the unpressurized unit rather than in the sealing regions of the shaft-driven machine.

In various embodiments of the present invention, the pressurized unit is mounted on a support, so as to provide space for the portion of the piston rod that extends below the pressurized unit. In some of these embodiments, the unpressurized unit is attached above the pressurized unit, while in other of these embodiments an unpressurized unit is not included.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a functional cross-section diagram illustrating a prior art barrier fluid support system that includes a separate pressurized vessel, unpressurized vessel, and pressure-differential piston unit;

FIG. 2A is a cross-sectional illustration of a prior art pressurized barrier fluid support apparatus that incorporates a barrier fluid reservoir, a barrier fluid cooling system, and a pressure-differential piston unit all within a common unit;

FIG. 2B is a top view of the prior art apparatus of FIG. 2A;

FIG. 3 includes a cross-sectional view of an embodiment of the present invention and a schematic flow diagram indicating the flow of both pressurized and unpressurized barrier fluid between the embodiment and a shaft-driven machine;

FIG. 4 is close-up cross-sectional view of the embodiment of FIG. 3;

FIG. 5 is a cross-sectional view of an embodiment similar to the embodiment of FIG. 4, in which the pressurized unit includes a removable cover and a removable cylinder;

FIG. 6 is a cross-sectional view of an embodiment that is mounted on a support and does not include an unpressurized unit;

FIG. 7 is a cross-sectional view of an embodiment that is mounted on a support and includes an unpressurized unit attached above the pressurized unit, the two units having removable covers and the pressurized unit having a removable cylinder;

FIG. 8 is a perspective view of an embodiment that includes an unpressurized unit attached on top of a pressurized unit, a shared cover being located between the two units that serves as a common manifold for a plurality of fluid connections to both of the units, the top and bottom housings having been removed for cleaning; and

FIG. 9 is a perspective view of the embodiment of FIG. 8, shown with the top and bottom housings installed.

### DETAILED DESCRIPTION

The invention is capable of many embodiments. What is shown and described is intended to be representative but not limiting of the scope of the invention.

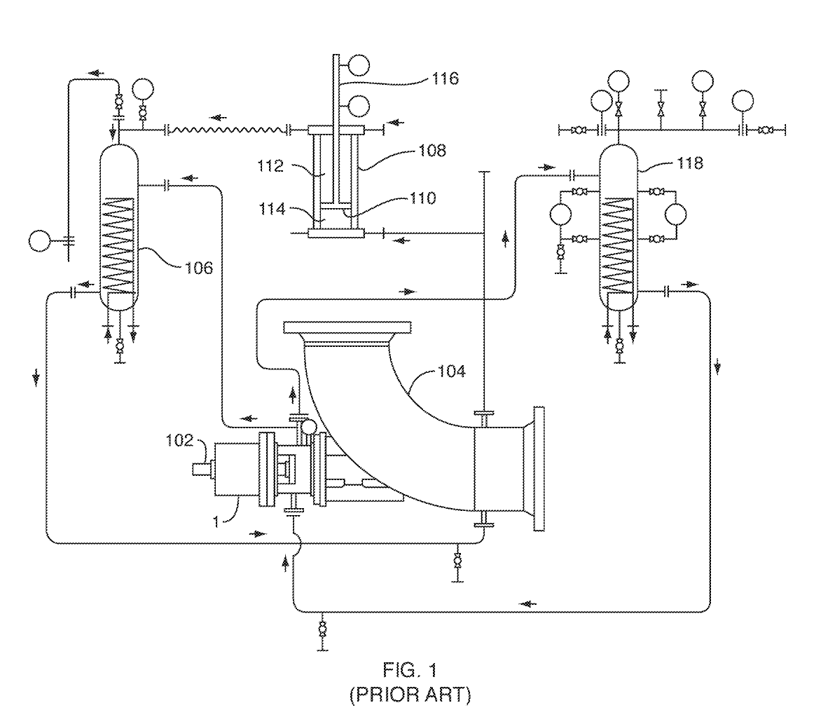

With reference to FIG. 1, the present invention is directed toward supporting seals in a shaft-driven machine 1. The seals allow a shaft 102 driven by the shaft-driven machine 1 to penetrate into a process environment 104, while preventing any leakage of process fluid out of the process environment 104. Typically, the seals require support by a pressurized barrier fluid system. For example, a pair of seals may define a region along the shaft that must be filled with barrier fluid maintained at a pressure higher than the pressure within the process environment 104. In addition, a safety seal may be included, and may define a region that must be filled with unpressurized barrier fluid.

FIG. 1 illustrates a typical prior art approach that includes separate systems for providing pressurized barrier fluid and unpressurized barrier fluid to the shaft-driven machine 1. In the pressurized barrier fluid system, a pressurized barrier fluid reservoir 106 cools and cleans the pressurized barrier fluid, while a separate piston system 108 maintains a pressure differential between the pressurized barrier fluid and the process environment 104. The piston system 108 includes a piston 110 that separates the interior of the piston system 108 into a barrier fluid region 112 and a pressure sensing region 114. The pressure sensing region 104 is maintained in pressure communication with the process environment 104, while an impeller (not shown) driven by the shaft 102 circulates pressurized barrier fluid between the barrier fluid region 112, the pressurized barrier fluid reservoir 106, and the shaft-driven machine 1.

A piston rod 116 extends upward from the piston 110 and slidably out of the barrier fluid region 112 through a sealed opening. The cross-sectional area of the piston rod 116 effectively reduces the surface area of the piston 110 on its barrier fluid side 112, and this causes the piston 110 to establish and maintain a pressure differential between the sensing region 114 and the barrier fluid region 112, thereby ensuring that the barrier fluid will always be at a higher pressure than the process region 104.

The prior art approach of FIG. 1 also includes a separate ambient pressure barrier fluid system with a separate ambient fluid reservoir 118 that cools and cleans the unpressurized barrier fluid. An impeller (not shown) mounted to the shaft 102 circulates the ambient pressure barrier fluid between the shaft-driven machine 1 and the ambient fluid reservoir 118. In addition, if the piston rod should become detached from the piston, it will likely be expelled from the piston vessel and could pose a significant hazard to nearby equipment and personnel.

All of these separate components require testing, certification, mounting, and plumbing, thereby consuming space and leading to high costs. Also, due to normal wear on the seal surfaces, debris tends to enter the pressurized bearing fluid and can be deposited on top of the piston 110, thereby tending to interfere with the operation of the piston system 108, and even causing the piston 110 to wear, leak, jam, or seize. Due to cost considerations, the reservoir 106 and/or the piston system 108 are typically welded shut, so that it is not easily possible to remove such debris from the reservoir 106 or the piston system 108.

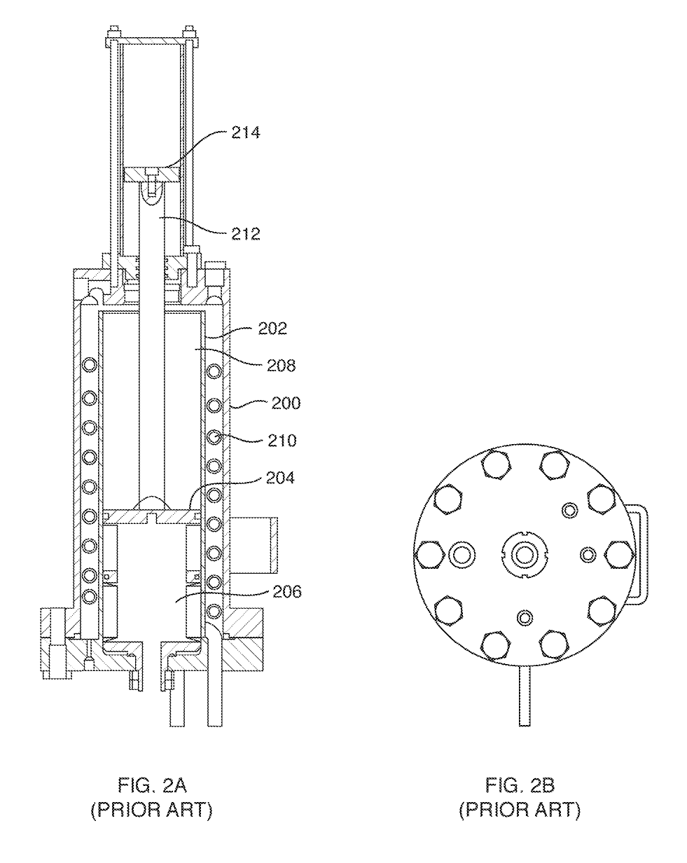

FIG. 2A illustrates a prior art approach that combines a pressurized barrier fluid reservoir with a piston system into a single unit. A pressure cell 200 contains a cylinder 202 within which a piston 204 slides vertically. The piston 204 divides a pressure sensing region 206 from a pressurized barrier fluid region 208. A cooling fluid coil 210 is located between the cylinder 202 and the wall of the pressure cell 200, and is able to cool the pressurized barrier fluid without interfering with movement of the piston 204. A piston rod 212 extends upward from the piston 204 and serves to reduce the effective surface area of the upper surface of the piston 204, thereby establishing the desired pressure differential between the barrier fluid and the process pressure. A level-indicating disk 214 is attached to the distal end of the piston rod 212 and is used to sense the position of the piston 204 within the cylinder 202. As with the prior art approach of FIG. 1, this prior art approach requires a separate unpressurized barrier fluid system to support a shaft-driven machine that requires ambient pressure barrier fluid in addition to pressurized fluid. Also, as in the approach of FIG. 1, debris will tend to collect on top of the piston 204 in this approach, and can cause failure of the piston, and if the piston rod should become detached from the piston, it will likely be expelled from the piston vessel and could pose a significant hazard to nearby equipment and personnel. In addition, the sophisticated plumbing required by this system significantly increases its cost of manufacture. FIG. 2B is a top view of FIG. 2A.

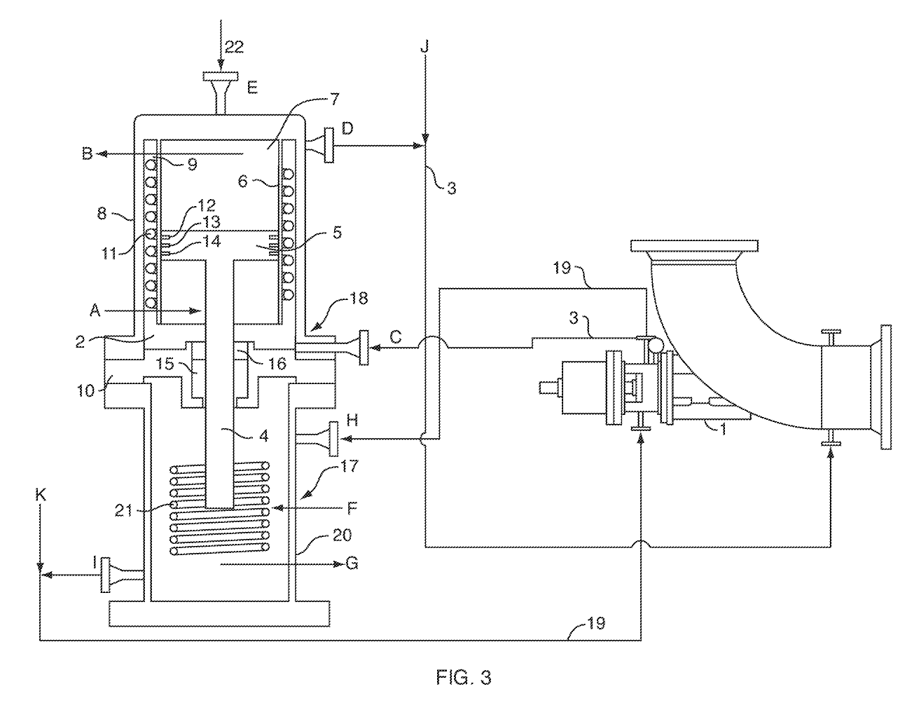

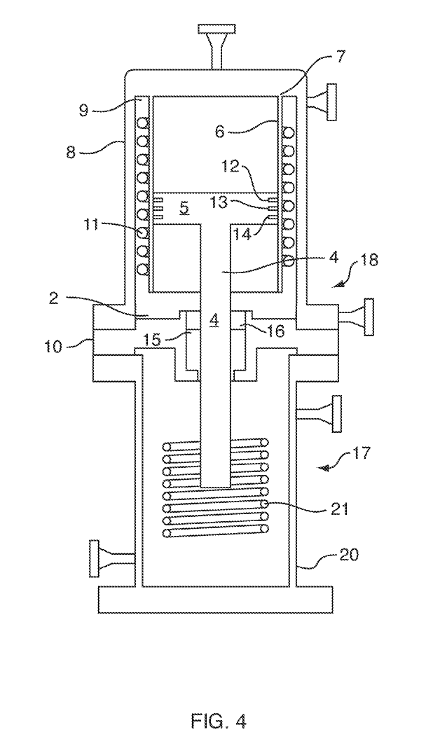

Referring to FIGS. 3 and 4, a first embodiment of the present invention combines a pressurized barrier fluid unit 18 and an unpressurized barrier fluid unit 17 into a single apparatus. The pressurized unit 18 is configured so as to place the barrier fluid region 2 below the piston 5, thereby causing any debris carried by the pressurized barrier fluid to gravitationally migrate downward and away from the piston 5. This arrangement also directs the piston rod 4 downward, and ensures that if the piston rod should become detached from the piston, it will be expelled toward the foundation, thereby minimizing any hazard to nearby equipment and personnel.

In the embodiment of FIGS. 3 and 4, interconnecting conduit 3 creates a pressurized barrier fluid circuit that connects the shaft-driven machine 1 with the barrier fluid region 2 of the pressurized unit 18. A piston rod 4 is attached to the piston 5 on the barrier fluid side 2, and passes through the barrier fluid region 2 and out of the pressure unit 18 through pressure seals 15. The pressure sensing region 7 is located above the piston 5, and is in pressure communication with the process fluid through a separate conduit 22.

The piston 5 in the embodiment of FIGS. 3 and 4 is coaxially mounted within a vertical cylinder 6 attached at its uppermost end to a pressure cell housing 8 having an inside diameter that is larger than the outside diameter of the cylinder 6, so that an annulus 9 is formed therebetween which is long enough to ensure that the piston 5 when depressed to its lowest extreme will remain engaged with the cylinder wall 6. A flanged cover 10 is bolted to the bottom of the pressure cell housing 8 and forms the lower boundary of the pressure unit 18, providing access to the interior of the pressure unit 18 for assembly, cleaning, and other maintenance.

A cooling coil 11 is wrapped concentrically within, and extends longitudinally along, the annulus 9 formed between the cylinder 6 and the pressure cell housing 8, said cooling coil 11 having an inlet connection A and an outlet connection B. The ends of the cooling coil 11 extend through the wall of the pressure cell housing 8 and are affixed integrally to the pressure cell housing 8 by means of welding or other pressure retaining means.

A plurality of commercially available piston rings (not shown) are fit into grooves 12-14 spaced along the outer diameter of the piston 5 and contact the inside surface of the cylinder 6, the lowermost piston ring being a commercially available scraper or wiper ring that scrapes any foreign debris from the cylinder wall during piston travel.

The piston rod 4 is concentric with, and is either rigidly mounted to or is integral with the longitudinal axis of the piston 5, extending axially downward therefrom and passing through commercially available radial seals 15 mounted in a concentric opening in the pressure unit cover 10, the seals 15 thereby controlling external leakage along the piston rod 5 from the barrier fluid chamber 2. In the embodiment of FIGS. 3 and 4, the topmost seal 16 is a commercially available wiper seal that scrapes any foreign debris from the piston rod during piston travel.

Connections C, D and E are affixed integrally to the pressure cell housing 8 by means of welding or other pressure retaining means. Connection C is the barrier fluid inlet to the pressure unit 18, and is located below the cooling coil 11. Connection D is the barrier fluid outlet from the pressure unit 18, and is located above the cooling coil inside the annulus 9 formed between the cylinder 6 and the pressure cell housing 8. Connection E is the sensing fluid connection located at the top of the pressure unit 18 and in pressure communication with the process fluid.

A connection J is also provided for replenishment of pressurized barrier fluid that may leak during operation. In FIG. 3 connection J is located on the interconnecting piping 3 of the pressurized barrier fluid circuit. In other embodiments, connection J can be a separate connection to the barrier fluid region 2 of the pressurization unit 18.

The pressurized unit 18 is coaxially conjoined with an unpressurized unit 17 that serves as an unpressurized barrier fluid reservoir for an unpressurized barrier fluid system. Interconnecting piping 19 connects the unpressurized unit 17 with a secondary mechanical seal chamber on the shaft of the shaft-driven machine.

The unpressurized unit 17 includes a housing 20 with a flanged opening onto which the flanged bottom cover 10 of the assembled pressurization unit 18 is attached, the flanged cover 10 thereby serving as a common cover 10 for both the pressurized unit 18 and the unpressurized unit 17. In the embodiment of FIGS. 3 and 4, the piston rod 4 of the pressurized unit 18 extends into the unpressurized unit 17 along the unpressurized unit's longitudinal axis. This arrangement further enhances the safety of the system, since a detached piston rod 4 will be contained within the unpressurized unit 17, and will not pose a danger to surrounding equipment or personnel. A cooling coil 21 is included within the unpressurized unit 17, said cooling coil 21 having an inlet F and an outlet G that penetrate the housing 20 of the unpressurized unit 17 and are affixed integrally to the housing 20 by means of welding or other fluid retaining means. Similar, additional connections to the unpressurized unit 17 include a barrier fluid inlet H, a barrier fluid outlet I, and a vent connection (not shown). A connection K can also be provided for replenishing unpressurized barrier fluid that may leak during operation. In FIG. 3, connection K is located on the interconnecting piping 19 of the unpressurized barrier fluid circuit. In other embodiments, connection K can be an additional connection located anywhere on the housing 20 of the unpressurized unit 17. There may be additional connections (not shown) on the housing 20 for mounting instrumentation that measures fluid level, pressure, temperature, and such like.

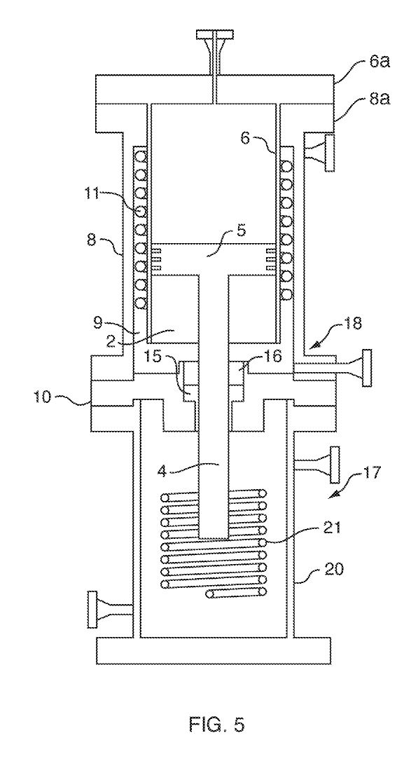

FIG. 5 depicts a second embodiment of the present invention that is similar to the embodiment of FIGS. 3 and 4, except that the cylinder 6 is attached to a concentric flange 6a that is removably mounted onto a mating flange 8a at the top of the pressure cell housing 8, such that the concentric flange 6a and cylinder 6 can be removed as a unit from the pressure unit 18 for enhanced access and easy cleaning.

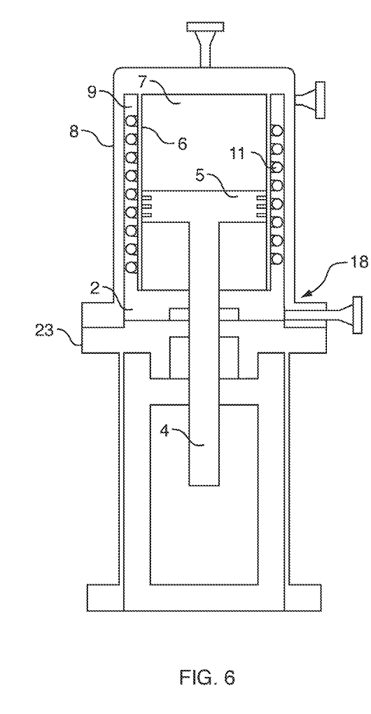

In a third embodiment, illustrated in FIG. 6, an unpressurized system is not included. In this embodiment, the pressurization unit 18 is mounted on a support 23 at a height greater than the available piston stroke. In FIG. 6, the top of support 23 replaces cover 10 of the pressurization unit 18. In similar embodiments, the cover 10 of pressurization unit 18 is retained, and is mounted to a mating flange of the support 23.

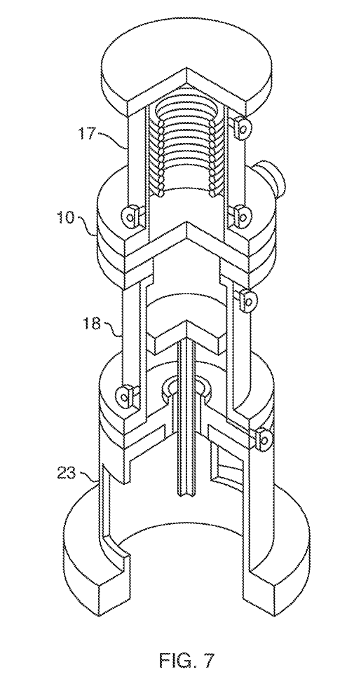

In a fourth embodiment, illustrated in FIG. 7, the unpressurized unit 17 is mounted on top of the pressurized unit 18, which is supported by a support 23.

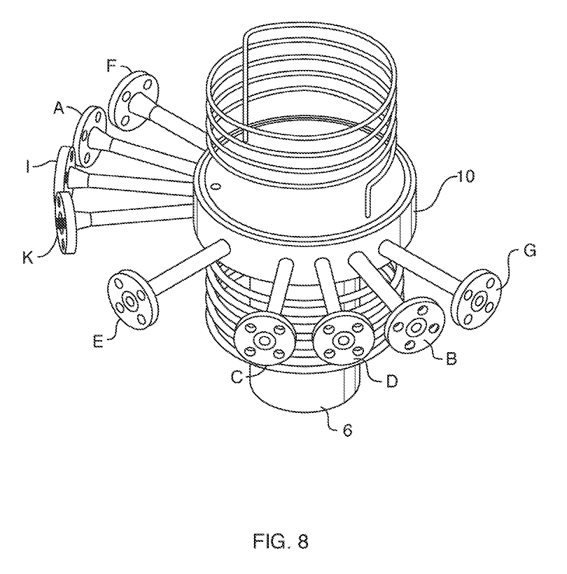

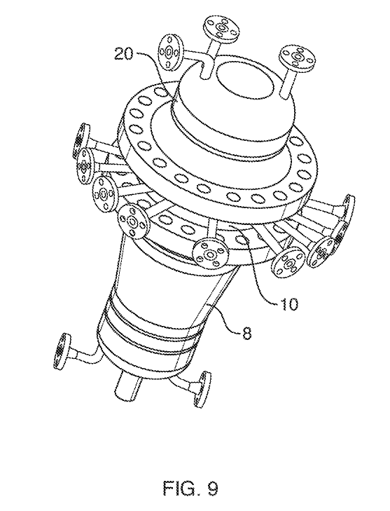

In a fifth embodiment, illustrated in FIG. 8, the common cover 10 serves as a manifold for a plurality of piping connections to both the pressurized unit 18 and the unpressurized unit 17, reducing the number of penetrations of the pressurized housing 8 and the unpressurized housing 20 of FIG. 9, and thereby reducing cost. The letters identifying the connections in FIG. 8 correspond to those used in FIG. 3. The housings 8, 20 of the pressurized unit 18 and the unpressurized unit 17 have been omitted in FIG. 8. FIG. 9 is an illustration of the embodiment of FIG. 8 with the housings 8, 20 installed. The housings 8, 20 terminate in flanges that are significantly larger in diameter than the shared manifold cover 10. Hence, the shared manifold cover 10 is not visible in FIG. 9. When fully assembled, bolts (not shown) are inserted through the bolt-holes indicated in FIG. 9 in the flanges of the two housings 8, 20. Tightening of these bolts causes the housings 8, 20 to press toward each other, trapping the shared manifold cover 10 between them and forming a seal therewith.

Referring again to FIG. 3, in preparation for operation, the pressurized barrier fluid system is filled with barrier fluid. The sensing region 7 of the pressurized unit 18 and its interconnecting conduit 22 are connected to a sensing source that is full of sensing fluid. The piston 5 can be located anywhere along the longitudinal axis of the cylinder 6 so long as it is above the lowest point of available piston travel. As a general practice, barrier fluid will be added through connection J until the piston is positioned in close proximity to the top of the cylinder 6. A means of adding or replenishing barrier fluid (not shown) is typically provided by an auxiliary pump (not shown) that supplies barrier fluid from an external reservoir (not shown) to the pressurized barrier fluid circuit by way of connection J to the circuit's interconnecting piping 3, or by an additional connection (not shown) to the barrier fluid region of the pressurization unit 18.

In operation, barrier fluid is circulated between the shaft-driven machine 1 and the pressurization unit 18 by a circulation pump (not shown). The circulation pump (not shown) may be either driven by the shaft 2 of the shaft-driven machine 1, or by an independent pump (not shown) connected to the interconnecting piping 3 of the pressurized barrier fluid circuit. The entire pressurized barrier fluid system, comprising the pressurization unit 18, the pressurized sealing chamber (not shown) in the shaft-driven machine 1, and the interconnecting piping 3, is full of barrier fluid.

Pressurized barrier fluid enters the annulus 9 formed between the cylinder 6 and the pressure cell housing 8 and flows past the cooling coils 11, which remove heat from the barrier fluid that has been added by the normal operation of the mechanical seals in the shaft-driven machine 1. The barrier fluid then exits the pressurization unit 18 at connection D. Cooling media is supplied to the cooling coils 11 by an external source, entering the coils 11 at connection A and exiting at connection B.

The sensing region 7 of the pressurization unit 18 is filled with sensing fluid. Sensing connection E communicates by way of interconnecting conduit 22 to the process side of the shaft-driven machine 1 so that the pressure in the sensing region 7 is always equal to the process pressure in the shaft-driven machine 1.

The sensing fluid pressure acts on the exposed upper surface of the piston 5, creating a downward force. Because the barrier fluid region 2 is hydrostatically full, there is an equal and opposing force generated on the barrier fluid side 2 of the piston 5. The effective area upon which the opposing force acts on the barrier fluid side 2 is reduced by the cross-sectional area of the piston rod 4 that extends out of the pressurization unit 18. Therefore, a greater force-per-unit-area is required on the barrier fluid side 2 of the piston 5, and hence the barrier fluid must be at a higher pressure than the sensing fluid in the sensing region 7 so as to provide an equal, balancing force on the barrier side 2 of the piston 5. Thus, regardless of any fluctuations of the process pressure, the hydrostatic pressure in the barrier fluid circuit is always maintained at a constant percentage above the process pressure.

The pressurization unit 18 acts as a reservoir for pressurized barrier fluid. Leakage occurs from the barrier circuit across mechanical seal faces (not shown) into the shaft-driven machine 1. As pressurized barrier fluid is consumed by this leakage, the piston 5 is displaced downward by an inflow of sensing fluid that corresponds to the volume of pressurized barrier fluid lost. Thus a constant pressure is maintained in the pressurized barrier fluid circuit despite losses, so long as the piston 5 does not reach the bottom of the cylinder 6.

In the course of operation, debris enters the barrier fluid as a result of mechanical seal wear in the shaft-driven machine 1. The debris enters the pressurization unit 18 at connection C, whereupon its velocity is reduced by approximately the ratio between the area under the piston 5 and the cross-sectional area of connection C. Debris that has a higher density than the barrier fluid settles by gravity onto the lower pressure unit cover 10. Removal of debris from the pressurized barrier fluid circuit in this manner prevents recirculation of the debris back to the shaft-driven machine 1, and extends mechanical seal life by preventing accelerated seal wear due to conveyance of the debris across the mechanical seal faces in the shaft-driven machine 1.

As the piston 5 is displaced due to barrier fluid leakage, the scraper rings 14 and topmost piston rod seal 16 remove accumulated debris from both the walls of the cylinder 6 and the piston rod 4 respectively, that otherwise might interfere with smooth travel of the piston 5. Debris that is removed by the scraper rings settles on the pressurization unit cover 10, and is well removed from the normal stroke path of the piston.

The unpressurized unit 17 barrier fluid circuit is partially filled with barrier fluid. A means of adding or replenishing unpressurized barrier fluid (not shown) is provided generally by an auxiliary pump (not shown) that supplies barrier fluid from an external source to the unpressurized barrier fluid circuit by way of a connection K to the circuit's interconnecting piping 19, or by an additional connection to the unpressurized unit 17.

In operation, unpressurized barrier fluid is circulated between the shaft-driven machine 1 and the unpressurized barrier unit 17 by a circulation pump (not shown). The circulation pump (not shown) may be either driven by an impeller fixed to the shaft 2 of the shaft-driven machine 1, or by an independent pump (not shown) attached to the interconnecting conduit 19 of the unpressurized barrier fluid circuit. The entire unpressurized barrier fluid system is unpressurized, including the unpressurized barrier fluid unit 17, the unpressurized sealing region in the shaft-driven machine 1, and the interconnecting piping 19.

Barrier fluid enters the unpressurized unit 17 at connection H and flows past the cooling coils 21 to remove heat from the unpressurized barrier fluid that has been added by the normal operation of the mechanical seals (not shown) in the shaft-driven machine 1, before exiting the unpressurized unit 17 at connection I. Cooling media is supplied by an external source to the cooling coils 21 by means of connection F, and exits at connection G.

Any leakage from a high pressure area of the shaft-driven machine to the unpressurized seal chamber in the shaft-driven machine will also accumulate in the unpressurized unit 17, and will eventually exit through a reservoir vent (not shown) to a suitable collection or disposal point. Instrumentation can be installed to detect and sound an alarm in the event that the unpressurized barrier fluid level exceeds a predetermined limit.

The invention is susceptible of other variations, embodiments and equivalents. For example, one general aspect of the present invention is an apparatus for supplying pressurized barrier fluid to a shaft-driven machine. The apparatus includes a pressure cell having an interior suitable for containing the pressurized barrier fluid at its operating pressure, a piston that divides the interior of the pressure cell into a sensing volume that is bounded in part by an upper surface of the piston, and a barrier fluid volume that is bounded in part by a lower surface of the piston, the piston being vertically mobile within the interior of the pressure cell so as to maintain a pressure differential between the sensing volume and the barrier fluid volume, the barrier fluid volume being configured so as to cause any debris included in the barrier fluid volume to gravitationally migrate downward and away from the piston, and a piston rod attached to the lower surface of the piston and extending downward therefrom, the piston rod extending slidably through a fluid-sealed passage formed in a lower boundary of the pressure cell, the piston rod thereby extending below and outside of the pressure cell, the piston rod having a cross-sectional area that causes a pressure-responsive area of the lower surface of the piston to be less than a pressure-responsive area of the upper surface of the piston, thereby establishing the pressure differential.

Some embodiments further include a hollow cylinder fixed vertically within the interior of the pressure cell, the piston being movably located therein and forming a fluid seal therewith. Other of these embodiments further include a pressure cell cooling fluid coil that is able to cool pressurized barrier fluid located within the barrier fluid volume, the pressure cell cooling fluid coil being located in a region that is bounded by an outer surface of the cylinder and an inner surface of the pressure cell.

In various embodiments, the cylinder is removable from the pressure cell. In other embodiments, the pressure cell includes a cover that is removable so as to provide access to the interior of the pressure cell.

Certain of these embodiments further include at least one piston ring cooperative with the piston and enhancing the fluid seal between the piston and the cylinder. And in some of these embodiments at least one of the piston rings is a wiper ring or a scraper ring.

In some embodiments, the fluid-sealed opening in the pressure cell through which the piston rod extends includes at least one of a scraper ring and a wiper ring. Other embodiments further include a vertical support stand attached to the lower boundary of the pressure cell and having a void therein configured so as to accommodate the extension of the piston rod below the pressure cell.

A second general aspect of the present invention is an apparatus for supplying both pressurized and unpressurized barrier fluid to a shaft-driven machine. The apparatus includes a pressure cell having an interior suitable for containing the pressurized barrier fluid at its operating pressure, a piston dividing the interior of the pressure cell into a sensing volume bounded in part by a first surface of the piston, and a barrier fluid volume bounded in part by a second surface of the piston, the piston being mobile within the interior of the pressure cell so as to maintain a pressure differential between the sensing volume and the barrier fluid volume, a piston rod attached to the second surface of the piston and extending slidably through a fluid-sealed passage formed in a boundary of the pressure cell, the piston rod thereby extending outside of the pressure cell, the piston rod having a cross-sectional area that causes a pressure-responsive area of the second surface of the piston to be less than a pressure-responsive area of the first surface of the piston, thereby establishing the pressure differential, and an unpressurized cell having an unpressurized interior suitable for containing unpressurized barrier fluid, the unpressurized cell being at least physically attached to the pressure cell.

Some embodiments further include a hollow cylinder fixed vertically within the interior of the pressure cell, the piston being movably located therein and forming a fluid seal therewith. And some of these embodiments further include a pressure cell cooling fluid coil that is able to cool pressurized barrier fluid located within the barrier fluid volume, the pressure cell cooling fluid coil being located in a region that is bounded by an outer surface of the cylinder and an inner surface of the pressure cell. In other of these embodiments the cylinder is removable from the pressure cell.

In some embodiments the pressure cell includes a cover that is removable so as to provide access to the interior of the pressure cell.

Various embodiments further include at least one piston ring cooperative with the piston and enhancing the fluid seal between the piston and the cylinder. And in some of these embodiments, at least one of the piston rings is a wiper ring or a scraper ring.

In some embodiments the fluid-sealed opening in the pressure cell through which the piston rod extends includes at least one of a scraper ring and a wiper ring. Other embodiments further include an unpressurized cell cooling fluid coil that is able to cool unpressurized barrier fluid located within the unpressurized interior. In still other embodiments, the attachment of the unpressurized cell to the pressure cell overlaps the fluid-sealed passage and allows the piston rod to extend into the unpressurized interior of the unpressurized cell.

In certain embodiments, the unpressurized cell is attached to a lower portion of the pressure cell. In other embodiments, the unpressurized cell is attached to an upper portion of the pressure cell. In some embodiments the barrier fluid volume of the pressure cell is configured so as to cause any debris included in the barrier fluid volume to gravitationally migrate downward and away from the piston.

In various embodiments the pressure cell and the unpressurized cell are conjoined by a shared manifold cover, the shared manifold cover including a plurality of manifold fluid ports. And in some of these embodiments, the plurality of manifold fluid ports includes a barrier fluid inlet, a barrier fluid outlet, a sensing fluid inlet, an unpressurized fluid inlet port, an unpressurized fluid outlet port, a pressurized unit cooling fluid inlet port, a pressurized unit cooling fluid outlet port, an unpressurized unit cooling fluid inlet port, and/or an unpressurized unit cooling fluid outlet port.

A third general aspect of the present invention is a system for imparting rotary motion within a sealed process environment. The system includes a shaft-driving mechanism, a shaft that is driven by the shaft-driving mechanism and extends into the sealed process environment, a pressurized sealing region formed along the shaft and suitable for containing pressurized barrier fluid at a pressure higher than a pressure of the sealed process environment, the pressurized sealing region being bounded by a first pressure seal and a second pressure seal, the first pressure seal forming a barrier between the process environment and the pressurized sealing region, an unpressurized sealing region formed along the shaft between the second pressure seal and a safety seal, the unpressurized sealing region being suitable for containing barrier fluid substantially at ambient pressure, a pressure cell having an interior suitable for containing the pressurized barrier fluid at its operating pressure, a piston dividing the interior of the pressure cell into a sensing volume bounded in part by an upper surface of the piston, and a barrier fluid volume bounded in part by a lower surface of the piston, the sensing volume being in pressure communication with the process environment and the barrier fluid volume being in circulating fluid communication with the pressurized sealing region, the piston being vertically mobile within the interior of the pressure cell so as to maintain a pressure differential between the sensing volume and the barrier fluid volume, the barrier fluid volume being configured so as to cause any debris included in the barrier fluid volume to gravitationally migrate downward and away from the piston, a hollow cylinder fixed vertically within the interior of the pressure cell, the piston being movably located therein and forming a fluid seal therewith, a pressure cell cooling fluid coil that is able to cool pressurized barrier fluid located within the barrier fluid volume, the pressure cell cooling fluid coil being located in a region that is bounded by an outer surface of the cylinder and an inner surface of the pressure cell, a piston rod attached to the lower surface of the piston and extending downward therefrom, the piston rod extending slidably through a fluid-sealed passage formed in a lower boundary of the pressure cell, the piston rod thereby extending below and outside of the pressure cell, the piston rod having a cross-sectional area that causes a pressure-responsive area of the lower surface of the piston to be less than a pressure-responsive area of the upper surface of the piston, thereby establishing the pressure differential, an unpressurized cell having an unpressurized interior suitable for containing unpressurized barrier fluid, the unpressurized interior being in circulating fluid communication with the unpressurized sealing region, the unpressurized cell being conjoined with the pressure cell by a shared manifold cover, the shared manifold cover including a plurality of manifold fluid ports.

In some embodiments, the manifold fluid ports include a barrier fluid inlet, a barrier fluid outlet, a sensing fluid inlet, an unpressurized fluid inlet port, an unpressurized fluid outlet port, a pressurized unit cooling fluid inlet port, a pressurized unit cooling fluid outlet port, an unpressurized unit cooling fluid inlet port, and/or an unpressurized unit cooling fluid outlet port.

Other embodiments further include an impeller driven by the shaft so as to circulate barrier fluid between the pressurized barrier fluid volume and the pressurized sealing region. And still other embodiments further include an impeller driven by the shaft so as to circulate barrier fluid between the unpressurized interior and the unpressurized sealing region.

In certain embodiments the pressure cell includes a cover that is removable so as to provide access to the interior of the pressure cell. And in various embodiments the cylinder is removable from the pressure cell.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. An apparatus for supplying pressurized barrier fluid to a shaft-driven machine, the apparatus comprising:
a pressure cell having an interior suitable for containing the pressurized barrier fluid at its operating pressure;
a piston that divides the interior of the pressure cell into a sensing volume that is bounded in part by an upper surface of the piston, and a barrier fluid volume that is bounded in part by a lower surface of the piston, the piston being vertically mobile within the interior of the pressure cell so as to maintain a pressure differential between the sensing volume and the barrier fluid volume, the barrier fluid volume being configured so as to cause any debris included in the barrier fluid volume to gravitationally migrate downward and away from the piston; and
a piston rod attached to the lower surface of the piston and extending downward therefrom, the piston rod extending slidably through a fluid-sealed passage formed in a lower boundary of the pressure cell, the piston rod thereby extending below and outside of the pressure cell, the piston rod having a cross-sectional area that causes a pressure-responsive area of the lower surface of the piston to be less than a pressure-responsive area of the upper surface of the piston, thereby establishing the pressure differential.

2. The apparatus of claim 1, further comprising a hollow cylinder fixed vertically within the interior of the pressure cell, the piston being movably located therein and forming a fluid seal therewith.

3. The apparatus of claim 2, further comprising a pressure cell cooling fluid coil that is able to cool pressurized barrier fluid located within the barrier fluid volume, the pressure cell cooling fluid coil being located in a region that is bounded by an outer surface of the cylinder and an inner surface of the pressure cell.

4. The apparatus of claim 2, wherein the cylinder is removable from the pressure cell.

5. The apparatus of claim 1, wherein the pressure cell includes a cover that is removable so as to provide access to the interior of the pressure cell.

6. The apparatus of claim 1, further comprising at least one piston ring cooperative with the piston and enhancing the fluid seal between the piston and the cylinder.

7. The apparatus of claim 6, wherein at least one of the piston rings is one of a wiper ring and a scraper ring.

8. The apparatus of claim 1, wherein the fluid-sealed opening in the pressure cell through which the piston rod extends includes at least one of a scraper ring and a wiper ring.

9. The apparatus of claim 1, further comprising a vertical support stand attached to the lower boundary of the pressure cell and having a void therein configured so as to accommodate the extension of the piston rod below the pressure cell.

10. An apparatus for supplying both pressurized and unpressurized barrier fluid to a shaft-driven machine, the apparatus comprising:
a pressure cell having an interior suitable for containing the pressurized barrier fluid at its operating pressure;
a piston dividing the interior of the pressure cell into a sensing volume bounded in part by a first surface of the piston, and a barrier fluid volume bounded in part by a second surface of the piston, the piston being mobile within the interior of the pressure cell so as to maintain a pressure differential between the sensing volume and the barrier fluid volume;
a piston rod attached to the second surface of the piston and extending slidably through a fluid-sealed passage formed in a boundary of the pressure cell, the piston rod thereby extending outside of the pressure cell, the piston rod having a cross-sectional area that causes a pressure-responsive area of the second surface of the piston to be less than a pressure-responsive area of the first surface of the piston, thereby establishing the pressure differential; and
an unpressurized cell having an unpressurized interior suitable for containing unpressurized barrier fluid, the unpressurized cell being at least physically attached to the pressure cell.

11. The apparatus of claim 10, further comprising a hollow cylinder fixed vertically within the interior of the pressure cell, the piston being movably located therein and forming a fluid seal therewith.

12. The apparatus of claim 11, further comprising a pressure cell cooling fluid coil that is able to cool pressurized barrier fluid located within the barrier fluid volume, the pressure cell cooling fluid coil being located in a region that is bounded by an outer surface of the cylinder and an inner surface of the pressure cell.

13. The apparatus of claim 11, wherein the cylinder is removable from the pressure cell.

14. The apparatus of claim 10, wherein the pressure cell includes a cover that is removable so as to provide access to the interior of the pressure cell.

15. The apparatus of claim 10, further comprising at least one piston ring cooperative with the piston and enhancing the fluid seal between the piston and the cylinder.

16. The apparatus of claim 15, wherein at least one of the piston rings is one of a wiper ring and a scraper ring.

17. The apparatus of claim 10, wherein the fluid-sealed opening in the pressure cell through which the piston rod extends includes at least one of a scraper ring and a wiper ring.

18. The apparatus of claim 10, further comprising an unpressurized cell cooling fluid coil that is able to cool unpressurized barrier fluid located within the unpressurized interior.

19. The apparatus of claim 10, wherein the attachment of the unpressurized cell to the pressure cell overlaps the fluid-sealed passage and allows the piston rod to extend into the unpressurized interior of the unpressurized cell.

20. The apparatus of claim 10, wherein the unpressurized cell is attached to a lower portion of the pressure cell.

21. The apparatus of claim 10, wherein the unpressurized cell is attached to an upper portion of the pressure cell.

22. The apparatus of claim 10, wherein the barrier fluid volume of the pressure cell is configured so as to cause any debris included in the barrier fluid volume to gravitationally migrate downward and away from the piston.

23. The apparatus of claim 10, wherein the pressure cell and the unpressurized cell are conjoined by a shared manifold cover, the shared manifold cover including a plurality of manifold fluid ports.

24. The apparatus of claim 23, wherein the plurality of manifold fluid ports includes at least one of:
a barrier fluid inlet;
a barrier fluid outlet;
a sensing fluid inlet;
an unpressurized fluid inlet port;
an unpressurized fluid outlet port;
a pressurized unit cooling fluid port;
an unpressurized unit cooling fluid inlet port; and
an unpressurized unit cooling fluid outlet port.

25. A system for imparting rotary motion within a sealed process environment, the system comprising:
a shaft-driving mechanism;
a shaft that is driven by the shaft-driving mechanism and extends into the sealed process environment;
a pressurized sealing region formed along the shaft and suitable for containing pressurized barrier fluid at a pressure higher than a pressure of the sealed process environment, the pressurized sealing region being bounded by a first pressure seal and a second pressure seal, the first pressure seal forming a barrier between the process environment and the pressurized sealing region;
an unpressurized sealing region formed along the shaft between the second pressure seal and a safety seal, the unpressurized sealing region being suitable for containing barrier fluid substantially at ambient pressure;
a pressure cell having an interior suitable for containing the pressurized barrier fluid at its operating pressure;
a piston dividing the interior of the pressure cell into a sensing volume bounded in part by an upper surface of the piston, and a barrier fluid volume bounded in part by a lower surface of the piston, the sensing volume being in pressure communication with the process environment and the barrier fluid volume being in circulating fluid communication with the pressurized sealing region, the piston being vertically mobile within the interior of the pressure cell so as to maintain a pressure differential between the sensing volume and the barrier fluid volume, the barrier fluid volume being configured so as to cause any debris included in the barrier fluid volume to gravitationally migrate downward and away from the piston;
a hollow cylinder fixed vertically within the interior of the pressure cell, the piston being movably located therein and forming a fluid seal therewith;
a pressure cell cooling fluid coil that is able to cool pressurized barrier fluid located within the barrier fluid volume, the pressure cell cooling fluid coil being located in a region that is bounded by an outer surface of the cylinder and an inner surface of the pressure cell;
a piston rod attached to the lower surface of the piston and extending downward therefrom, the piston rod extending slidably through a fluid-sealed passage formed in a lower boundary of the pressure cell, the piston rod thereby extending below and outside of the pressure cell, the piston rod having a cross-sectional area that causes a pressure-responsive area of the lower surface of the piston to be less than a pressure-responsive area of the upper surface of the piston, thereby establishing the pressure differential;
an unpressurized cell having an unpressurized interior suitable for containing unpressurized barrier fluid, the unpressurized interior being in circulating fluid communication with the unpressurized sealing region, the unpressurized cell being conjoined with the pressure cell.

26. The apparatus of claim 25, wherein the unpressurized cell is conjoined with the pressure cell by a shared manifold cover, the shared manifold cover including a plurality of manifold fluid ports.

27. The apparatus of claim 26, wherein the manifold fluid ports include at least one of:
a barrier fluid inlet;
a barrier fluid outlet;
a sensing fluid inlet;
an unpressurized fluid inlet port;
an unpressurized fluid outlet port;
a pressurized unit cooling fluid port;
an unpressurized unit cooling fluid inlet port; and
an unpressurized unit cooling fluid outlet port.

28. The apparatus of claim 25, further comprising an impeller driven by the shaft so as to circulate barrier fluid between the pressurized barrier fluid volume and the pressurized sealing region.

29. The apparatus of claim 25, further comprising an impeller driven by the shaft so as to circulate barrier fluid between the unpressurized interior and the unpressurized sealing region.

30. The apparatus of claim 25, wherein the pressure cell includes a cover that is removable so as to provide access to the interior of the pressure cell.

31. The apparatus of claim 25, wherein the cylinder is removable from the pressure cell.
